(19) United States
(12) Patent Application Publication
(10) Pub. No.: US 2010/0291444 A1
(43) Pub. Date: Nov. 18, 2010

(54) MULTILAYER COATINGS FOR RECHARGEABLE BATTERIES

(76) Inventors: Joseph C. Farmer, Tracy, CA (US); James Kaschmitter, Pleasanton, CA (US)

Correspondence Address: LLNL/Zilka-Kotab;John H. Lee, Assistant Laboratory Counsel, Lawrence Livermore National Laboratory, L-703, P.O. Box 808, Livermore, CA, 94551, US

(21) Appl. No.: 12/778,975

(22) Filed: May 12, 2010

Related U.S. Application Data
(60) Provisional application No. 61/177,522, filed on May 12, 2009.

(51) Int. Cl. H01M 6/18

(52) U.S. Cl. 429/322; 29/623.5

(57) ABSTRACT

A method for producing a rechargeable battery in the form of a multi-layer coating in one embodiment includes applying an active cathode material above an electrically conductive and electrochemically compatible substrate to form a cathode; applying a solid-phase ionically-conductive electrolyte material above the cathode as a second coating to form an electrode separation layer; applying an anode material above the electrode separation layer to form an anode; and applying an electrically conductive overcoat material above the anode. A method for producing a multi-layer coated cell in another embodiment includes applying an anode material above a substrate to form an anode; applying a solid-phase electrolyte material above the anode to form an electrode separation layer; applying an active cathode material above the electrode separation layer to form a cathode; and applying an electrically conductive overcoat material above the cathode. Cells are also disclosed.

### RELATED APPLICATIONS

This application claims priority to provisional U.S. Appl. No. 61/177,522 filed on May 12, 2009, which is herein incorporated by reference.

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to energy production, and more particularly, to systems and methods for multi-layer coatings for bipolar rechargeable batteries.

### BACKGROUND

Electrochemical energy storage is currently used in many different portable applications, such as wireless communications and portable computing, just to name a few, and will be essential for the realization of future fleets of electric and hybrid electric vehicles, which are now believed to be an essential part of the world's strategy for reducing our dependence on oil and minimizing the impact of gaseous emissions of CO and CO₂ on climate change. In looking at possible materials that can be used for anodes in electrochemical energy conversion and storage systems, lithium appears to have one of the highest specific capacities, in terms of Ah/kg. See FIG. 1 which is a plot showing rankings of conventional anode materials. Hydrogen is typically used to power fuel cells, while lithium is typically used in advanced rechargeable battery cells and batteries.

Most currently used energy storage systems use lithium ion battery chemistry, with graphite anodes that intercalate lithium upon charging, mixed transition metal oxide cathodes that intercalate lithium during discharge, a micro-porous polyethylene electrode separator, and an electrolyte formed from a dielectric mixed solvent composed of organic carbonates, other solvents and high-mobility lithium salts. The movement of the lithium ions between the intercalation anodes and cathodes during charging and discharging is commonly known as the “rocking chair” mechanism.

Cells with liquid electrolytes are usually housed in cylindrical or prismatic metal cans, with stack pressure maintained by the walls of the can, while cells with polymer gel electrolytes are usually housed in soft-sided aluminum-laminate packages, with stack pressure achieved through thermal lamination of the electrodes and separators, thereby forming a monolithic structure.

Graphite powder is used as the active material for anodes, is coated onto thin copper foils that serve as current collectors for the anodes, and is held in place by a polyvinyl idene fluoride (PVDF) binder. Transition metal oxide powder is used as the active material for cathodes, and is coated onto thin aluminum foils that serve as current collectors for the cathode, and is held in place by a PVDF binder. Both natural and manmade graphite, such as mesocarbon microbeads (MCMB), have been used for the anodes, while LiₓCoO₂, LiₓNiO₂, LiₓMn₂O₄, mixed transition metal oxides with cobalt, nickel, and manganese, and iron-phosphates, among others, are common choices for the cathode.

Over the past decade, these systems have attained outstanding specific energy and energy density, exceptional cycle life and rate capabilities that enable them to now be considered for both vehicular and power tool applications, in addition to their early applications in wireless communications and portable computing. The best commercially available, polymer-gel lithium ion battery now has a specific energy of greater than 180 Wh/kg, an energy density of greater than 360 Wh/L, and a reasonably good rate capability, allowing discharge over a broad range of C-rates.

Both liquid prismatic and polymer gel cells may be incorporated into large high-capacity power packs for electric vehicle and other applications. Such high capacity systems have state-of-the-art computerized charge and discharge control systems which include graphical user interfaces, and are capable of sensing for monitoring the health of individual cells, and balancing the charge of individual cells in large series-parallel arrays of cells.

Such lithium ion batteries, which rely on the rocking chair mechanism, are generally believed to be safer than those where lithium exists in the reduced metallic state. However, the use of flammable liquid-phase and two-phase polymer gel electrolytes, coupled with a high energy density, a relatively delicate about 20 micron thick polymeric separator, and the possibility of lithium plating and dendrite formation due to non-uniform stack pressure and electrode misalignment, has led to safety problems with these energy storage systems. One example of the type of unanticipated event with a lithium ion battery is evidenced by the rash of laptop battery fires experienced over recent years. The possibility of such an event occurring on commercial airliners, where many passengers carry laptop computers and cell phones with such batteries, is especially disconcerting. These events have occurred on much larger scales, and have caused industry-wide concern in the continued use of this important technology.

Adequate and intelligent thermal management in these cells is essential. High rates of charge or discharge drive the temperature upward due to resistive heating of the electrolyte. When the core temperature of these cells exceed a critical threshold (typically about 150° F.), the systems frequently become unstable, with the possible initiation of autocatalytic reactions, which can lead to thermal runaway and catastrophic results. Disproportionation of the transition metal oxides can liberate sufficient oxygen to support oxidation of the organic carbonate solvents used in the liquid or polymer-gel electrolytes. It is now recognized that while conventional systems provide high energy density, their safety remains problematic.

It would therefore be very beneficial to develop new battery materials and architectures that enhance the performance of rechargeable solid-state lithium-ion batteries, and that will provide high specific energy, high volumetric energy density, and high rate capability at high and/or low temperatures, e.g., about 0° C., with substantially improved safety and reliability through the elimination of combustible liquid organic solvents, to the greatest extent possible.

The battery industry has become extremely competitive, with lower prices placing pressure on battery manufacturers to optimize production processes, eliminating as many unnecessary production steps as possible. Great economic advantage could be achieved through reducing the number of steps involved in coating electrodes and fabricating separators, for example.

### SUMMARY

A method for producing a rechargeable battery in the form of a multi-layer coating in one embodiment includes applying an active cathode material above an electrically conductive and electrochemically compatible substrate to form a cathode; applying a solid-phase ionically-conductive electrolyte material above the cathode as a second coating to form an electrode separation layer; applying an anode material above the electrode separation layer to form an anode; and applying an electrically conductive overcoat material above the anode.

A method for producing a multi-layer coated cell in another embodiment includes applying an anode material above a substrate to form an anode; applying a solid-phase ionically-conductive electrolyte material above the anode to form an electrode separation layer; applying an active cathode material above the electrode separation layer to form a cathode; and applying an electrically conductive overcoat material above the cathode.

A lithium ion, other rechargeable, or primary cell formed on a single substrate according to one embodiment includes an active cathode material coated onto a substrate; a solid-phase electrolyte material positioned adjacent to the active cathode material; an anode material positioned adjacent to the solid-phase electrolyte material; and an electrically conductive overcoat material positioned adjacent to the anode material.

A lithium ion, other rechargeable, or primary cell formed on a single substrate according to another embodiment includes an anode material coated onto a substrate; a solid-phase electrolyte material positioned adjacent to the anode material; an active cathode material positioned adjacent to the solid-phase electrolyte material; and an electrically conductive overcoat material positioned adjacent to the active cathode material.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a plot showing range of pure materials that may be used as active materials in the anode layer or coating in a multilayer cell according to one embodiment.

FIG. 2 shows a plot of Li-ion liquid electrolyte conductivities, that establish targeted conductivities for electrode separation layer or coating in the multi-layer cell.

FIG. 3 shows a plot comparing energy storage technologies, with improvements possible with new multilayer cells according to some embodiments.

FIG. 4 shows a simplified schematic diagram of a cell, according to one embodiment.

FIG. 5 shows a comparison of possible hydrides that can be used to form a hydride electrode in a NiMH-type system, according to some embodiments.

FIG. 6 shows a flow chart of a method, according to one embodiment.

FIG. 7 shows a simplified schematic diagram of a cell, according to one embodiment.

FIG. 8 shows a simplified schematic diagram of a cell, according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

Most rechargeable polymer-gel lithium ion batteries are formed from (1) a cathode, made by coating an aluminum foil with a transition metal oxide active material, which is held in place with a PVDF binder; (2) an anode made by coating a copper foil with lithium-intercalated graphite material, also held in place with a PVDF binder; and (3) a micro-porous polyethylene separator, coated on both sides with porous layers of PVDF. These three materials are wound together to form the complete cell. Other packaging materials are also required.

Embodiments of the present invention include a novel multi-functional multi-layer coating process for fabrication of an entire cell on a single metal foil backing. For example, in one variation, the active cathode material is first applied to an aluminum foil or substrate, followed by application of a second coating that serves as a solid-phase electrolyte. After application of the electrolyte layer, the anode coating is applied, along with an electrically conductive over coat. The coating for the cathode and anode layers may be similar to those used in conventional lithium ion batteries, with the exception of the polymeric binder in some approaches, which in addition to PVDF, can also include ionically conductive polymers to facilitate lithium transport in the interstitial spaces of the electrodes. The electrode separation layer may be formed from particles of inorganic solid-state ion conductors (e.g., Li-ion conductors, Na-ion conductors, etc.), dispersed in a polymeric binder. The particles may be hard or not hard. In further approaches, the particles may be ceramic.

In one example, the preferred binder in the electrode separation layer is an ion exchange polymer, with high lithium ion mobility, or another polymeric electrolyte material appropriate for a conventional lithium ion battery such as a solid polymer electrolyte or a polymer-gel electrolyte. Note that polymer-gel electrolytes are preferred for use with anodes that involve the anodic oxidation of lithium with the formation of lithium ions, the anodic oxidation of sodium with the formation of sodium ions, and the like. The ion-conductive polymer may be a polymer with anionic sulfonate groups substituted onto a carbon-based backbone. PVDF may also be used as a binder in the electrode separation layer.

Embodiments of the present invention dramatically reduce production costs, by employing for example, a single multi-layer coating on a single foil backing substituted for two coated foils, and a coated polyethylene separator. Once fabricated, the multi-layer multi-functional coating can be used with conventional packaging materials. In addition to using this approach for the construction of lithium-based rechargeable, and primary batteries, it can also be applied to other battery chemistries, such as the nickel metal hydride system.

In one general embodiment, a method for producing a rechargeable battery in the form of a multi-layer coating includes applying an active cathode material above an electrically conductive and electrochemically compatible substrate to form a cathode, applying a solid-phase ionically-conductive electrolyte material above the cathode as a second coating to form an electrode separation layer, applying an anode material above the electrode separation layer to form an anode, and applying an electrically conductive overcoat material above the anode, thereby e.g., enabling the fabrication of a lithium ion cell with fewer production steps than required for the fabrication of conventional lithium-ion cells. This embodiment also enables the use of safer cell materials.

In another general embodiment, a method for producing a multi-layer coated cell includes applying an anode material above an electrically conductive and electrochemically compatible substrate to form an anode, applying a solid-phase electrolyte material above the anode to form an electrode separation layer, applying an active cathode material above the electrode separation layer to form a cathode, and applying an electrically conductive overcoat material above the cathode.

In one embodiment, solid-state electrolyte materials with exceptionally high mobility (Table 1) are produced in the form of powders or granules, These powders can then be used to prepare slurries with appropriate solvents and binders. The binder phase used in the electrode separation layer cannot be electrically conductive, but may be ion conductive. These slurries can then be used for coating either an anode or cathode layer, thereby forming the electrode separation layer, which is mechanically robust, thermochemically stable, and inherently safe.

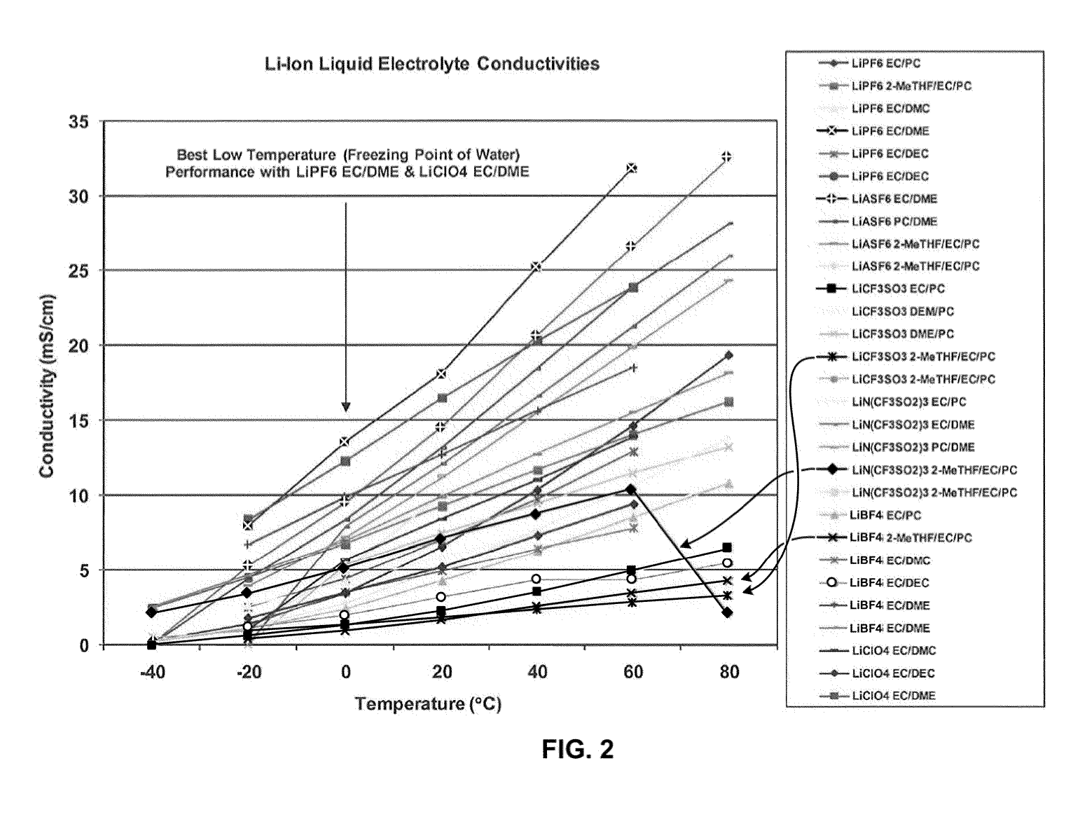

In another embodiment, the electrode separation layer, which is still applied as a coating, may consist solely of an organic solid-polymer electrolyte. The thickness of this layer is preferably less than about 25 microns, and the electrolyte conductivity is preferably between 1 mS/cm and 15 mS/cm at 0° C., with greater ionic conductivity being even better. Since separators in conventional lithium ion batteries have comparable thicknesses, the use of a 25-micron thick layer would not compromise the overall energy density of the fabricated cell (Wh/L). By maintaining the ionic conductivity of the electrode separation layer in the stated range, and within the range of ionic conductivities of liquid phase electrolytes shown in FIG. 2, compromises in rate capability with the new cell architecture are avoided. In another embodiment, solid polymer electrolytes, with higher ion conductivity than conventional binders, may be used alone, or in conjunction with conventional binder materials as the binder phase to hold active anode and cathode materials onto their respective current collectors. The attributes of the molecular structure that impact ion mobility include: (1) the specific cation exchange group substituted onto the polymer backbone, (2) the distance between adjacent cation exchange groups, (3) the impact of other substituent groups on ion mobility, (4) the impact of cross-linking, and (5) the effects of temperature and potential.

In another embodiment, by incorporating hard powders of inorganic ion-conductive materials into the polymeric material, a robust composite separator material may be formed between the two electrodes, with enhanced mobility and resistance to shorting. A graded composite is possible, where inorganic particles in the polymer matrix transition from transition metal oxides at the cathode interface, to ion-conductive particles in the separator region, to graphitic particles at the anode interface, according to preferred approaches.

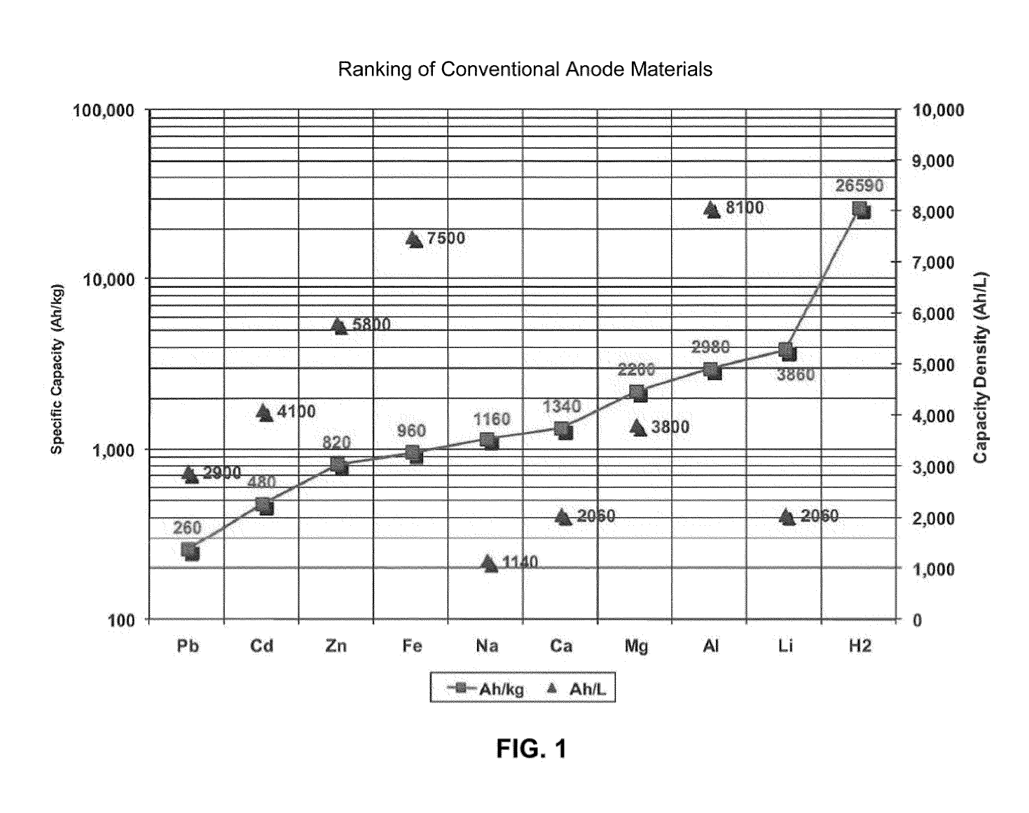

In another embodiment, the anode layer or coating can comprise any of the pure materials shown in FIG. 1 (e.g., Pb, Cd, Zn, Fe, Na, Ca, Mg, Al, and Li with at least 98% purity), alloys of two or more those pure materials, or compounds of those pure materials as the active material. Additional alloys which may be used in the anode layer include lithium-silicon alloy, lithium-tin alloys, any intercalation compound or alloy of sodium, etc. The anode may also be a hydride, as discussed below.

Advanced anode materials, according to some embodiments, may be developed and/or used to provide specific capacities (Ah/kg) and capacity densities (Ah/L) approaching the limits for lithium, which are approximately 3860 Ah/kg and 2060 Ah/L, respectively, in some approaches, which exceeds the performance of currently available and known materials. For comparison purposes, intercalated graphite (LiₓC₆) is the industry standard the active anode material in lithium-ion batteries, and has a theoretical specific capacity of 372 Ah/kg, and a theoretical capacity density of 837 Ah/L (the practical values are lower than these theoretical values due to dilution with inert non-reactive materials). The advanced anode materials, in some embodiments, exceed the theoretical values for the industry standard materials by a substantial margin.

According to some embodiments, active cathode materials may be used in the cathode layer that have a specific capacity of greater than 274 Ah/kg, and a capacity density of greater than 1017 Ah/L. For comparison purposes, lithium cobalt oxide (LiₓCoO₂) is the industry standard for the active material used to fabricate cathodes in lithium-ion battery cells, and has a theoretical specific capacity of 274 Ah/kg, and a theoretical capacity density of 1017 Ah/L (the practical values are lower than these theoretical values). The advanced cathode materials, in some approaches, exceed the theoretical values for the industry standard materials, once again, by a factor of two.

In addition to conventional electrode materials, novel materials and structures can be used. Such materials include: Si and CoO₂ nanowires; titanates; nano-structural metal foam electrodes with electrodeposited or sputtered lithium, and ion conductive polymer infiltration; and non-stoichiometric oxide fillers with metal-like electrical conduction.

Ultimately, an inexpensive, easy-to-manufacture, inherently safe, high-energy, high-rate solid-state rechargeable battery may be fabricated as described here.

TABLE 1
Examples of Solid-State Ion-Conductive Materials That
Can Be Used in the Robust Electrode-Separation Layer

| | | | | Capacity | Energy |
|---|---|---|---|---|---|
| | | | | Density | Density |
| Dates | Electrolyte | σ (S m⁻¹) | Cell System | (Ah/L) | (Wh/L) |
| 1950-1960 | AgI | 10⁻³ | Ag/V₂O₅ | | |
| 1960-1965 | Ag₃SI | 1 | Ag/I₂ | 750 | 510 |
| 1965-1972 | RbAg₄I₅ | 30 | Ag/Me₄NI₅ | | |
| 1965-1975 | β-(Al₂O₃)₁₁(Na₂O)₁ | 3 | Na—Hg/I₂(PC) | 540 | 1600 |
| 1970-1975 | LiI(Al₂O₃) | 10⁻³ | Li/PbI₂ | | |
| 1970-1980 | LiI | 10⁻⁵ | Li/I₂(P2VP) | 690 | 1900 |
| 1978-1985 | LiX-PEO | 10⁻⁵ | Li/V₂O₅ | | |
| 1980-1986 | Li_{0.36}I_{0.14}O_{0.007}P_{0.11}S_{0.38} | 5 × 10⁻² | Li/TiS₂ | | |
| 1983-1987 | MEEP | 10⁻² | Li/TiS₂ | | |
| 1985-1992 | Plasticized SPE | 10⁻¹ | Li/V₆O₁₃ | | |
| 1985-1992 | Li_{0.35}I_{0.12}O_{0.31}P_{0.12}S_{0.098} | 2 × 10⁻³ | Li/TiS₂ | | |
| 1990-1992 | Li_{0.39}N_{0.02}O_{0.47}P_{0.12} | 3 × 10⁻⁴ | Li/V₂O₅ | | |

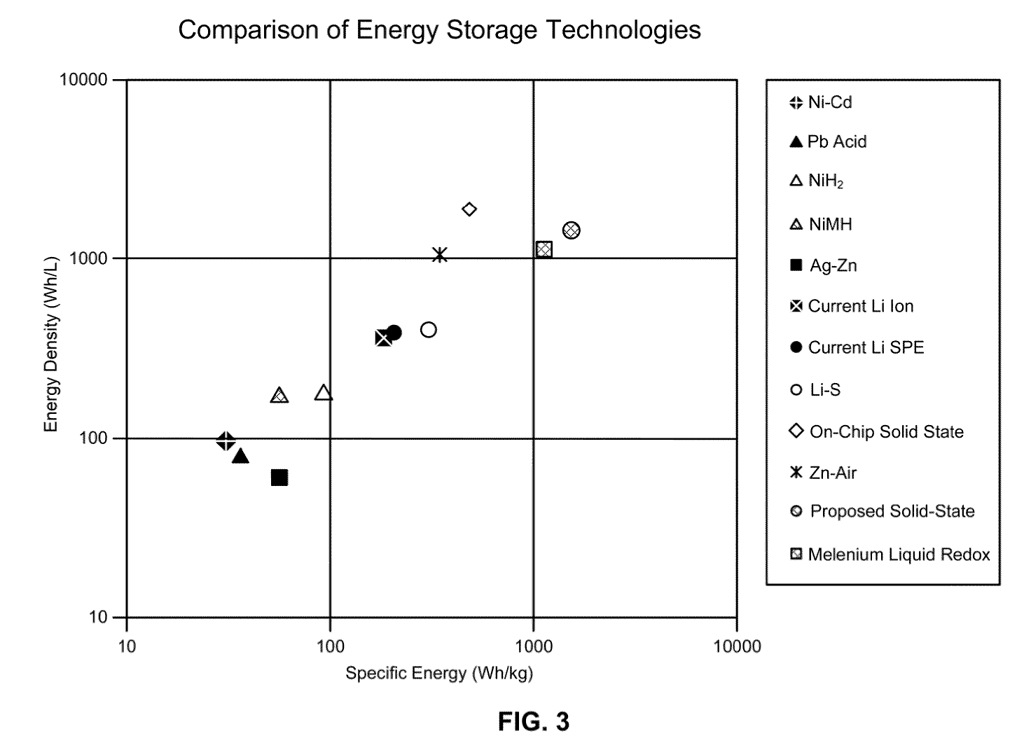

Several illustrative possibilities are summarized in FIG. 3, which is a comparison plot of energy storage technologies. The plot clearly shows that the cells and batteries disclosed herein, according to multiple embodiments, can be built in a manner to provide the highest combination of specific energy and energy density, as desired by the field, through the elimination of excessive inert battery materials. Of course other configurations are also possible, and can be built with the objective of eliminating processing steps and achieving a lower production cost.

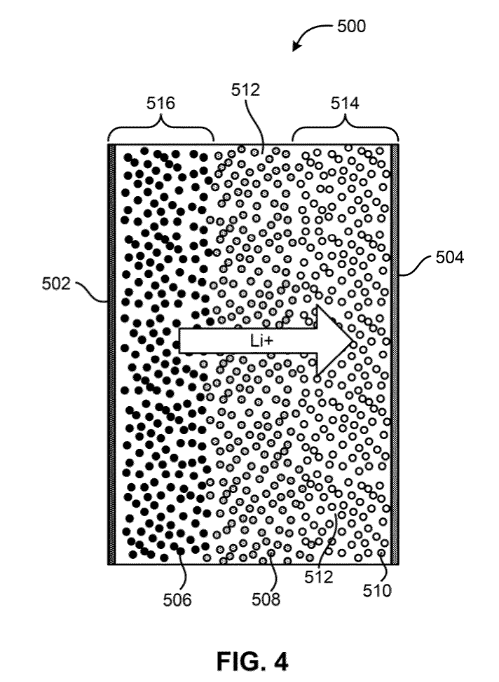

In some embodiments of the present invention, rechargeable lithium ion batteries are formed from a cathode (typically made by coating, e.g., an aluminum foil, with a transition metal oxide active material, which may be held in place, e.g., with a polyvinylidene fluoride (PVDF) binder), an anode (typically made by coating, e.g., a copper foil with lithium-intercalated material e.g., lithium-intercalated graphite, LiC₆, etc. also possibly held in place, e.g., with a PVDF binder), and a micro-porous, e.g., polyethylene separator (typically coated on both sides with porous layers of, e.g., PVDF). These three materials are typically wound together to form the complete cell. Other packaging materials are also used as required and/or desired. A conceptual drawing of such a multi-layer multi-functional cell is shown in FIG. 4, according to one embodiment.

FIG. 4 shows a simplified schematic diagram of a cell 500, according to one embodiment. This embodiment begins with the anode current collector on the substrate, building from there. However, the order of formation is not critical, i.e., the cathode or anode side may be formed first. Thus, for example, the cell of FIG. 4 may be created by forming layers from right to left as shown in the FIG., or left to right. This is true for other embodiments of the present invention.

With continued reference to FIG. 4, the cell 500 may be a lithium ion cell formed on a single substrate 502 or 504. For the present discussion, the substrate is assumed to be 504. In some approaches, the substrate 504 may be a metal foil, as would be known to one of skill in the art, such as a copper foil, aluminum foil, etc. depending on the adjacent layer of active material. The cell 500 comprises an active cathode material 510 coated onto the substrate 504, a solid-phase electrolyte material 508 positioned adjacent to the active cathode material 510, an anode material 506 positioned adjacent to the solid-phase electrolyte material 508, and an electrically conductive overcoat material 502 positioned adjacent to the anode material 506. The electrically conductive overcoat material 502 may be a metal foil, in some embodiments, such as an aluminum foil, a copper foil, etc. depending on the adjacent layer of active material.

According to one embodiment, the active cathode material 510 and the anode material 506 may comprise an ionically conductive polymer 512 to facilitate lithium transport in interstitial spaces of a cathode 514 and an anode 516, respectively. In further approaches, the ionically conductive polymer 512 may comprise a polymer with anionic sulfonate groups substituted onto a carbon-based backbone. In more approaches, the polymer 512 may comprise PVDF with or without an ionically conductive material, a polymer with anionic sulfonate groups substituted onto a carbon-based backbone, etc.

In another approach, the solid-phase electrolyte material 508 may comprise particles of inorganic solid-state lithium ion conductors dispersed in a polymeric binder 512, the binder 512 being an ion exchange polymer with high lithium mobility, another polymeric electrolyte material, etc. According to a further approach, the ion exchange polymer may comprise a polymer with anionic sulfonate groups substituted onto a carbon-based backbone.

According to one embodiment, a multi-functional multi-layer coating process for fabrication of an entire cell on a single metal foil backing is provided. For example, in one variation, the active cathode material may first be applied to an aluminum foil or substrate, followed by application of a second coating that serves as a solid-phase electrolyte. After application of the electrolyte layer, the anode coating may be applied in one embodiment, along with an electrically conductive overcoat. A final coating can be used for encapsulation.

The coating for the cathode and anode layers are similar to those used in conventional lithium ion batteries, with the exception of the polymeric binder, which in addition to PVDF, can also include ionically conductive polymers to facilitate lithium transport in the interstitial spaces of the electrodes.

The separator is formed from particles of inorganic solid-state lithium ion conductors, in one embodiment, dispersed in a polymeric binder. In this case, the preferred binder is an ion exchange polymer or a solid polymer electrolyte, with high lithium ion mobility, or another polymeric electrolyte material appropriate for a conventional lithium ion battery. The ion-conductive polymer may be a polymer with anionic sulfonate groups substituted onto a carbon-based backbone.

In one embodiment, a single multi-layer coating on a single foil backing substituted for two coated foils and a coated polyethylene separator dramatically reduces production costs. Once fabricated, the multi-layer multifunctional coating may be used with conventional packaging materials. The composite electrolyte layer has ion-conductive solid particles, which provide very high compressive strength for this layer (electrode separation layer), and helps prevent shorts and dendrite penetration, in some approaches. By using hard ion-conductive particles, the separator not only has compressive strength, but also high ion mobility.

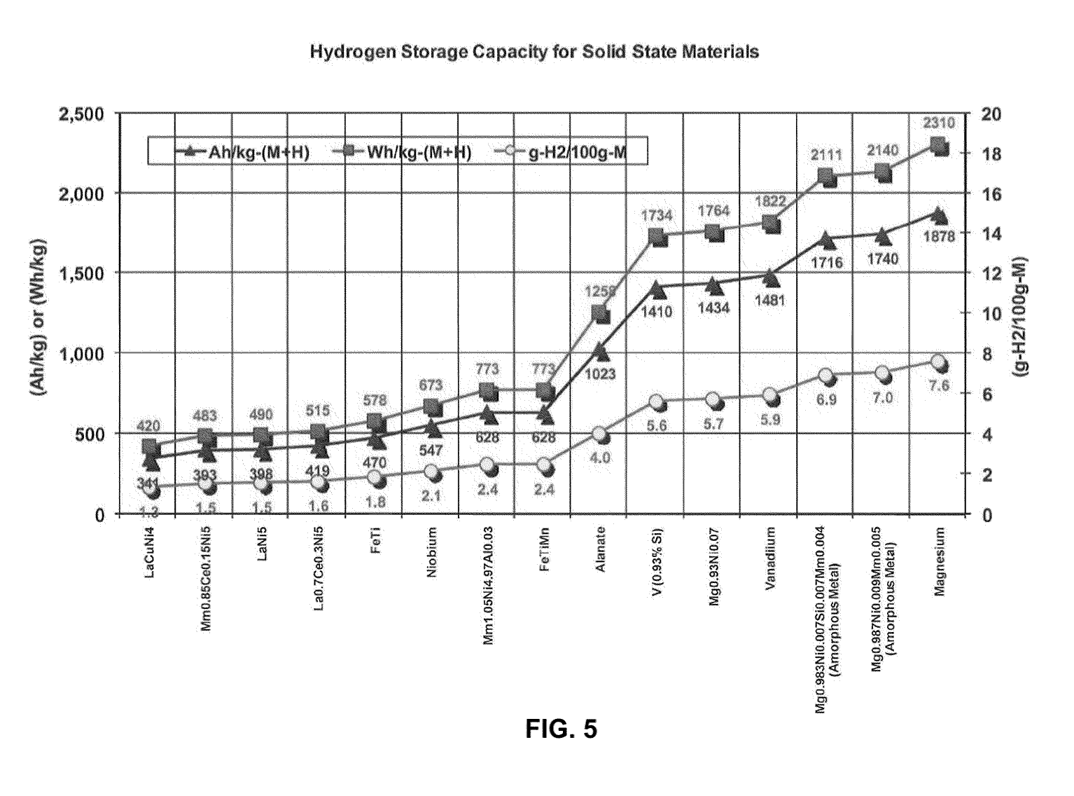

In addition to using this approach for the construction of lithium-based rechargeable and primary batteries, it may also be applied to other battery chemistries, such as the nickel metal hydride (NiMH) system, and proton exchange membrane (PEM) fuel cells. A wide variety of hydrides can be used, as illustrated FIG. 5. Additional hydrides suitable for use in the anode, in addition to those found in FIG. 5, include palladium, tantalum and/or zirconium

The particles used in any of the functional layers or coatings may be in the form of round, oval, cylindrical, prismatic or irregular shaped particles, with dimensions ranging from several nanometers to several hundred microns.

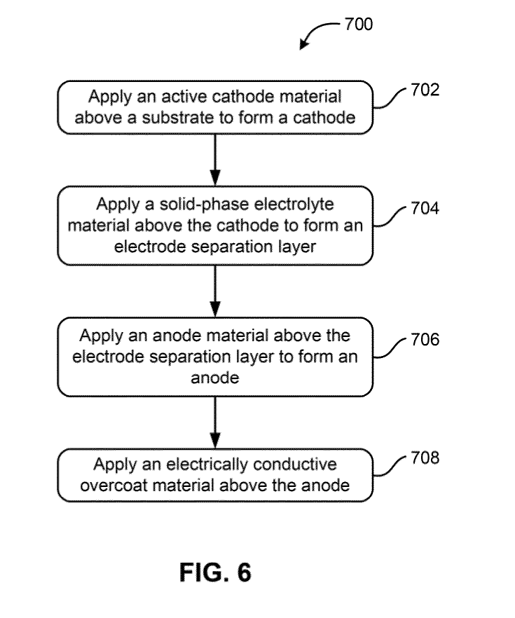

Now referring to FIG. 6, a method 700 for producing a multi-layer coated cell is shown according to one embodiment. This method 700 may be carried out in any desired environment, and may be applied to production of various types of cells, including lithium ion cells, nickel metal hydride (NiMH) cells, proton exchange membrane (PEM) fuel cells, etc. Moreover, while the cathode is described as being formed first, one skilled in the art will appreciate that the operations described below may be rearranged with slight or no modification to form the anode side first.

In operation 702, an active cathode material is applied above a substrate to form a cathode. Any method of application may be used, including, but not limited to, slurry coating with doctor blade to control thickness, sputter coating, chemical vapor deposition (CVD), plasma-enhanced chemical vapor deposition (PECVD), physical vapor deposition (PVD), ion plating, electroplating, electroless plating, sol-gel deposition, spraying, dip-coating, etc.

In one approach, the substrate may comprise a metal foil. Any suitable, chemically compatible, metal foil as would be known to one of skill in the art may be used, such as metal foils capable of being used in a cell for a battery, a copper foil, an aluminum foil, etc. depending on the active material adjacent to the foil.

In one approach, the active cathode material may comprise an ionically conductive polymer as part of a binder phase to facilitate lithium transport in interstitial spaces of the cathode, between particles of active cathode material. In addition, the ionically conductive polymer may comprise a polymer with anionic sulfonate groups substituted onto a carbon-based backbone. In another approach, the polymer may comprise PVDF, alone or in combination with an ionically conductive material, a polymer with anionic sulfonate groups substituted onto a carbon-based backbone, etc.

In operation 704, a solid-phase electrolyte material is applied above the cathode to form an electrode separation layer. Any method of application may be used, including, but not limited to, slurry coating with doctor blade to control thickness, sputter coating, CVD, PECVD, PVD, ion plating, electroplating, electroless plating, sol-gel deposition, spraying, dip-coating, etc.

According to one approach, the solid-phase electrolyte material may comprise particles of inorganic solid-state lithium ion conductors dispersed in a polymeric binder. The binder may be PVDF, an ion exchange polymer with high lithium mobility, another polymeric electrolyte material, etc. In a further approach, the ion exchange polymer may comprise a polymer with anionic sulfonate groups substituted onto a carbon-based backbone.

In operation 706, an anode material is applied above the electrode separation layer to form an anode. Any method of application may be used, including, but not limited to, slurry coating with doctor blade to control thickness, sputter coating, CVD, PECVD, PVD, ion plating, electroplating, electroless plating, sol-gel deposition, spraying, dip-coating, etc.

In one approach, the anode material may comprise an ionically conductive polymer binder phase to facilitate lithium transport in interstitial spaces of the particles of anode active material. In addition, the ionically conductive polymer may comprise a polymer with anionic sulfonate groups substituted onto a carbon-based backbone. In another approach, the polymer may comprise PVDF, alone or in combination with an ionically conductive material, a polymer with anionic sulfonate groups substituted onto a carbon-based backbone, etc.

In operation 708, an electrically conductive overcoat material is applied above the anode. Any method of application may be used, including, but not limited to, slurry coating with doctor blade to control thickness, sputter coating, CVD, PECVD, PVD, ion plating, electroplating, electroless plating, sol-gel deposition, spraying, dip-coating, etc.

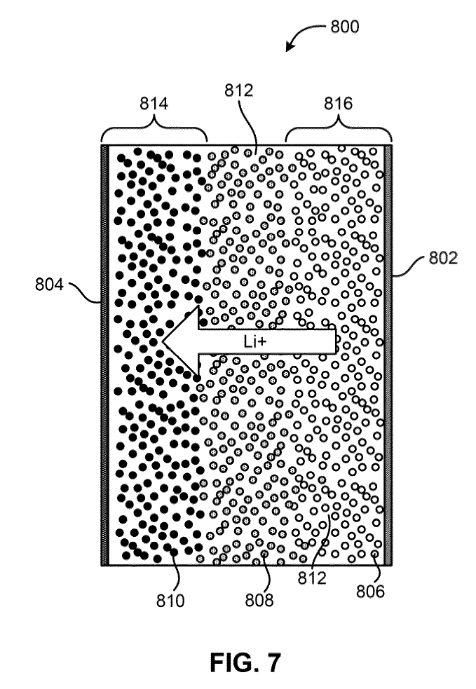

Now referring to FIG. 7, a cell 800 is shown according to one embodiment. The cell 800 may be a lithium ion cell formed on a single substrate 802. In some approaches, the substrate 802 may be a metal foil, as would be known to one of skill in the art, such as a copper foil, aluminum foil, etc. depending on the active material adjacent to the foil. The cell 800 comprises an anode material 806 coated onto the substrate 802, a solid-phase electrolyte material 808 positioned adjacent to the anode material 806, an active cathode material 810 positioned adjacent to the solid-phase electrolyte material 808, and an electrically conductive overcoat material 804 positioned adjacent to the active cathode material 810. The electrically conductive overcoat material 804 may be a metal foil, in some embodiments, such as an aluminum foil, a copper foil, etc. depending on the active material adjacent to the foil.

According to one embodiment, the active cathode material 810 and the anode material 806 may comprise an ionically conductive polymer 812 to facilitate lithium transport in interstitial spaces of a cathode 814 and an anode 816, respectively. In further approaches, the ionically conductive polymer 812 may comprise a polymer with anionic sulfonate groups substituted onto a carbon-based backbone. In more approaches, the polymer 812 may comprise PVDF alone or in combination with an ionically conductive material, a polymer with anionic sulfonate groups substituted onto a carbon-based backbone, etc.

In another approach, the solid-phase electrolyte material 808 may comprise particles of inorganic solid-state lithium ion conductors dispersed in a polymeric binder 812, the binder 812 being an ion exchange polymer with high lithium mobility, another polymeric electrolyte material, etc. According to a further approach, the ion exchange polymer may comprise a polymer with anionic sulfonate groups substituted onto a carbon-based backbone.

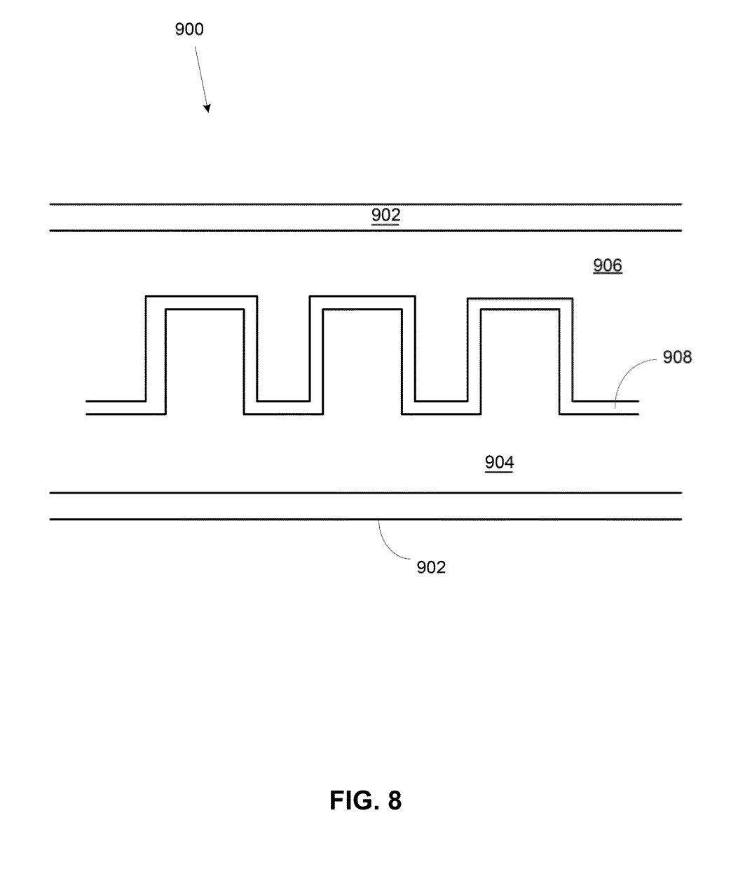

Yet another embodiment 900 is directed to an interdigitated comb-like anode and cathode structures on a single dielectric substrate 902, as shown in FIG. 8 in a top-down view. The substrate can be rigid, flexible, etc. and even sufficiently flexible to roll up. In an illustrative method of making such a cell 900, the comb-structure 904 for the anode is deposited in one coating step, while the comb-structure 906 for the cathode is deposited in another coating step, which may be performed in any order. The two structures 904, 906 lie in at least one common deposition plane, so members thereof are interdigitated. The electrode-separator layer 908 is then applied, and used to establish ionic communication between the two electrodes that coexist on the same dielectric substrate. The various layers may be formed of the materials presented above For example, the electrolyte coating or layer can be made of an appropriate solid polymer electrolyte, or as composite coating with ion-conductive or ceramic solid particles dispersed in an appropriate binder, which could be ion conductive:

Of course, similar materials, designs, and formation techniques may be used for any of the embodiments described herein, as desired. Each cell described herein may use, in addition to the approaches described relating to that cell, other approaches described in relation to other cells, such as formation techniques, materials, thicknesses, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for producing a rechargeable battery in the form of a multi-layer coating, the method comprising:
applying an active cathode material above an electrically conductive substrate to form a cathode;
applying a solid-phase ionically-conductive electrolyte material above the cathode as a second coating to form an electrode separation layer;
applying an anode material above the electrode separation layer to form an anode; and
applying an electrically conductive overcoat material above the anode.

2. The method of claim 1, wherein the active cathode material includes an ion-conductive polymer as part of a binder phase to facilitate ion transport in interstitial spaces of the cathode, between particles of the active cathode material.

3. The method of claim 1, wherein the anode material includes at least one pure solid-phase element selected from a group consisting of Pb, Cd, Zn, Fe, Na, Ca, Mg, Al, and Li.

4. The method of claim 1, wherein the anode material includes an alloy formed from at least two pure solid-phase elements selected from a group consisting of Pb, Cd, Zn, Fe, Na, Ca, Mg, Al, and Li.

5. The method of claim 1, wherein the anode material includes a hydride.

6. The method of claim 1, wherein the anode includes graphite.

7. The method of claim 1, wherein the anode includes an intercalation compound of lithium.

8. The method of claim 1, wherein the anode includes a lithium-silicon alloy.

9. The method of claim 1, wherein the anode includes a lithium-tin alloy.

10. The method of claim 1, wherein the anode material includes an intercalation compound or alloy of sodium.

11. The method of claim 1, wherein at least one of the anode material, cathode material and electrolyte material includes particles having a shape selected from a group consisting of round, oval, cylindrical, prismatic and irregular shape.

12. The method of claim 2, wherein the ion-conductive polymer in the binder phase comprises a polymer with anionic sulfonate groups substituted onto a carbon-based backbone.

13. The method of claim 2, wherein the ion-conductive polymer is combined with conventional binder materials.

14. The method of claim 1, wherein the anode includes an ion-conductive polymer to facilitate transport of cations in interstitial spaces of the anode, between particles of active anode material.

15. The method of claim 14, wherein the ion-conductive polymer comprises a polymer with anionic sulfonate groups substituted onto a carbon-based backbone.

16. The method of claim 14, wherein the ion-conductive polymer is used in conjunction with a conventional binder material such as polyvinylidene fluoride (PVDF) to form the binder phase.

17. The method of claim 1, wherein the electrode separation layer comprises hard particles of inorganic solid-state ion conductors dispersed in a polymeric binder, the binder being PVDF, an ion exchange polymer with high ion mobility, a solid polymer electrolyte, or a polymer-gel electrolyte.

18. The method of claim 1, wherein the electrode separation layer comprises hard particles of inorganic solid-state Li-ion conductors dispersed in a polymeric binder, the binder being PVDF, a Li-ion exchange polymer with high Li-ion mobility, a solid polymer electrolyte, or a polymer-gel electrolyte.

19. The method of claim 1, wherein the electrode separation layer comprises hard particles of inorganic solid-state Na-ion conductors dispersed in a polymeric binder, the binder being PVDF, an Na-ion exchange polymer with high Na-ion mobility, a solid polymer electrolyte, or a polymer-gel electrolyte.

20. The method of claim 1, wherein the electrode separation layer comprises hard ceramic particles dispersed in a polymeric binder, the binder being PVDF, an ion exchange polymer with high ion mobility, a solid polymer electrolyte, or a polymer-gel electrolyte.

21. The method of claim 1, wherein the electrode separation layer comprises hard ceramic particles dispersed in a polymeric binder, the binder being an Li-ion exchange polymer with high Li-ion mobility, a solid polymer electrolyte, or a polymer-gel electrolyte.

22. The method of claim 1, wherein the electrode separation layer comprises hard ceramic particles dispersed in a polymeric binder, the binder being an Na-ion exchange polymer with high Na-ion mobility, a solid polymer electrolyte, or a polymer-gel electrolyte, preferred for use with anodes that involve the anodic oxidation of sodium with the formation of sodium ions.

23. The method of claim 17, wherein the ion exchange polymer comprises a polymer with anionic sulfonate groups substituted onto a carbon-based backbone.

24. The method of claim 1, wherein the substrate comprises a metal foil.

25. A method for producing a multi-layer coated cell, the method comprising:
applying an anode material above a substrate to form an anode;
applying a solid-phase ionically-conductive electrolyte material above the anode to form an electrode separation layer;
applying an active cathode material above the electrode separation layer to form a cathode; and
applying an electrically conductive overcoat material above the cathode.

26. The method of claim 25, wherein the active cathode material comprises an ionically conductive polymer to facilitate lithium transport in interstitial spaces of the cathode.

27. The method of claim 26, wherein the ionically conductive polymer comprises a polymer with anionic sulfonate groups substituted onto a carbon-based backbone.

28. The method of claim 25, wherein cathode comprises polyvinylidene fluoride (PVDF).

29. The method of claim 25, wherein the anode material comprises an ionically conductive polymer to facilitate lithium transport in interstitial spaces of the anode.

30. The method of claim 29, wherein the ionically conductive polymer comprises a polymer with anionic sulfonate groups substituted onto a carbon-based backbone.

31. The method of claim 25, wherein the anode comprises polyvinylidene fluoride (PVDF).

32. The method of claim 25, wherein the solid-phase electrolyte material comprises particles of inorganic solid-state lithium ion conductors dispersed in a polymeric binder, the binder being PVDF, an ion exchange polymer with high lithium mobility or a polymeric electrolyte material.

33. The method of claim 32, wherein the ion exchange polymer comprises a polymer with anionic sulfonate groups substituted onto a carbon-based backbone.

34. The method of claim 26, wherein the substrate comprises a metal foil.

35. The method of claim 26, wherein at least one of the anode materials includes at a pure solid-phase element selected from a group consisting of Pb, Cd, Zn, Fe, Na, Ca, Mg, Al, Li, and alloys thereof.

36. The method of claim 26, wherein at least one of the anode materials includes a material selected from a group consisting of a hydride, a graphite, an intercalation compound of lithium, a lithium-silicon alloy, a lithium-tin alloy, and an intercalation compound or alloy of sodium.

37. A lithium ion, other rechargeable, or primary cell formed on a single substrate, the cell comprising:
an active cathode material coated onto a substrate;
a solid-phase electrolyte material positioned adjacent to the active cathode material;
an anode material positioned adjacent to the solid-phase electrolyte material; and
an electrically conductive overcoat material positioned adjacent to the anode material.

38. The cell of claim 37, wherein the active cathode material and the anode material comprise an ionically conductive polymer to facilitate lithium transport in interstitial spaces of a cathode and an anode, respectively.

39. The cell of claim 38, wherein the ionically conductive polymer comprises a polymer with anionic sulfonate groups substituted onto a carbon-based backbone.

40. The cell of claim 47, further comprising polyvinylidene fluoride (PVDF) binding at least one of the anode material and cathode material.

41. The cell of claim 37, wherein the solid-phase electrolyte material comprises particles of inorganic solid-state lithium ion conductors dispersed in a polymeric binder, the binder being PVDF, an ion exchange polymer with high lithium mobility or a polymeric electrolyte material.

42. The cell of claim 41, wherein the ion exchange polymer comprises a polymer with anionic sulfonate groups substituted onto a carbon-based backbone.

43. The cell of claim 37, wherein the substrate comprises a metal foil.

44. The cell of claim 37, wherein anode and cathode structures are positioned in a same deposition plane above the substrate and have interdigitated members with the electrolyte material therebetween.

45. The cell of claim 37, wherein at least one of the anode materials includes at a pure solid-phase element selected from a group consisting of Pb, Cd, Zn, Fe, Na, Ca, Mg, Al, Li, and alloys thereof.

46. The cell of claim 37, wherein at least one of the anode materials includes a material selected from a group consisting of a hydride, a graphite, an intercalation compound of lithium, a lithium-silicon alloy, a lithium-tin alloy, and an intercalation compound or alloy of sodium.

47. A lithium ion, other rechargeable, or primary cell formed on a single substrate, the cell comprising:
an anode material coated onto a substrate;
a solid-phase electrolyte material positioned adjacent to the anode material;
an active cathode material positioned adjacent to the solid-phase electrolyte material; and
an electrically conductive overcoat material positioned adjacent to the active cathode material.

48. The cell of claim 47, wherein the active cathode material and the anode material comprise an ionically conductive polymer to facilitate lithium transport in interstitial spaces of a cathode and an anode, respectively.

49. The cell of claim 48, wherein the ionically conductive polymer comprises a polymer with anionic sulfonate groups substituted onto a carbon-based backbone.

50. The cell of claim 47, further comprising polyvinylidene fluoride (PVDF) binding at least one of the anode material and cathode material.

51. The cell of claim 47, wherein the solid-phase electrolyte material comprises particles of inorganic solid-state lithium ion conductors dispersed in a polymeric binder, the binder being PVDF, an ion exchange polymer with high lithium mobility or a polymeric electrolyte material.

52. The cell of claim 51, wherein the ion exchange polymer comprises a polymer with anionic sulfonate groups substituted onto a carbon-based backbone.

53. The cell of claim 47, wherein the substrate comprises a metal foil.

54. The cell of claim 47, wherein anode and cathode structures are positioned in a same deposition plane above the substrate and have interdigitated members with the electrolyte material therebetween.

55. The cell of claim 47, wherein at least one of the anode materials includes at a pure solid-phase element selected from a group consisting of Pb, Cd, Zn, Fe, Na, Ca, Mg, Al, Li, and alloys thereof.

56. The cell of claim 47, wherein at least one of the anode materials includes a material selected from a group consisting of a hydride, a graphite, an intercalation compound of lithium, a lithium-silicon alloy, a lithium-tin alloy, and an intercalation compound or alloy of sodium.
